(19) United States
(12) Patent Application Publication
(10) Pub. No.: US 2016/0057938 A1
(43) Pub. Date: Mar. 3, 2016

(54) Lemna Based Protein Concentrate

(71) Applicant: Freddie Hebert, Gueydan, LA (US)

(72) Inventor: Freddie Hebert, Gueydan, LA (US)

(21) Appl. No.: 14/474,334

(22) Filed: Sep. 2, 2014

(51) Int. Cl. A01G 1/00

(52) U.S. Cl. CPC A01G 1/001

(57) ABSTRACT

Starch from the aquatic plant duckweed (Spirodela Polyrhiza) is fermented to produce an organic protein meal for feedstock. Fermentation is accomplished first by grinding the collected duckweed (lemna) then by the addition of 2 enzymes (e.g., Alpha Amylase and Glucomylase) in a cooker. Yeast is added in the fermenter to produce ethanol. The solids are centrifuged out after distillation of the ethanol through a stripper column. After the ethanol is stripped the solids are centrifuged out and the remaining thin stillage is recycled back to the aquatic plant growing area. This high nitrogen organically produced thin stillage provides 100% of the nitrogen needed to grow the Aquatic plant, so the process can be made 100% self-sustaining and certified organic.

### CLAIM OF PRIORITY

This patent application claims priority to provisional U.S. patent application No. 61/878,007, filed on Sep. 15, 2013.

### BACKGROUND

There are current winter shortages of organic protein concentrates causing their value to double in the last year, bringing another protein source into the market will help to stabilize prices.

Spirodela Polyrhiza (Giant Duckweed) is currently used in sewage treatment, and its growth rates are well documented. However growing this aquatic plant as an organic protein has never been considered because no economically viable fertilizer source exists. Currently only the protein, nitrogen sources of soybean meal, fish meal and other minor sources could be used to fertilize an organic growing system, but they are too costly to be considered for growing the aquatic plant Spirodela Polyrhiza.

### BRIEF DESCRIPTION OF THE DRAWING

FIG. 1 is a process flow diagram showing an example embodiment according to these teachings.

### DETAILED DESCRIPTION

According to an example embodiment, Organic Protein Meal is produced by extracting the starch thus concentrating the protein from the Aquatic Plant Spirodela Polyrhiza and other aquatic plants. Starch extraction is accomplished using 2 natural enzymes Alpha Amylase and Glucoamylase. The Aquatic plant Spirodela Polyrhiza is grown in a Certified Organic Nitrogen rich water supply. This water supply is furnished as a byproduct of the starch extraction process. The starch i s fermented to produce ethanol and yeast, the yeast production giving further value to the final protein number.

This invention allows the Organic feed Industry an alternative protein source comparable to Fish and Certified Organic Soybean Meal.

The process of producing Organic Protein concentrate according to these teachings can be easily reproduced and licensed. Licensed systems and engineering will be offered for installation at organic farming operations thus greatly reducing the daily feed cost for the operation.

Organic Protein concentrate according to these teachings be produced on site by recycling the nitrogen rich Process water from the ethanol production and solids removal process.

When growing the aquatic plant Spirodela Polyrhiza, using the Starch extraction process as described below, fermentation and protein recovery yields nitrogen rich process water that is recycled to the duckweed growing area thus reducing the need for organic sources of fertilizer.

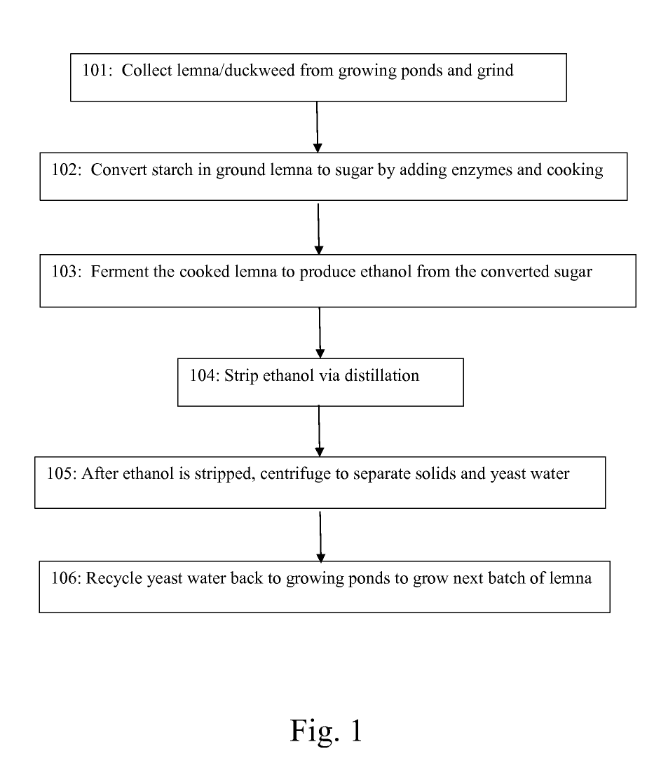

### Process Overview—FIG. 1

Lemna is grown in open ponds (typical in over 30 sewer treatments systems in Louisiana using Lemna for sewage treatment). Lemna is a genus of free-floating aquatic plants from the duckweed family.

Lemna is collected and ground using typical grinding methods, Colloid mill, sonication, etc. See 101 of FIG. 1.

Ground Lemna is cooked using 2 enzymes typically used in the craft brewing process. This cooking process converts the starch to sugar at step 102 of FIG. 1, and this sugar is then fermented to ethanol at step 103 of FIG. 1. The ethanol is stripped in a distillation column at step 104 and the solids are centrifuged out at step 105 of FIG. 1, leaving a thin stillage that is high in nitrogen content.

#1 One advantage of this invention is the process of recycling autolysed yeast water produced during step 105 of the process and not captured by the centrifuge. This yeast water containing ruptured yeast nitrogen is recycled back to the aquatic plant growing area at step 106 of FIG. 1, providing 100% of the nitrogen needed to grow the next batch of lemna, making the process 100% sustainable and self-supporting. Since 100% of the nitrogen needed to grow the next batch of lemna is provided by the recycled high nitrogen thin stillage, the entire process and thus the resulting protein meal made from this process is organic.

#2 Another advantage of an example embodiment is the addition of sugar beet molasses prior to step 103 to increase the variable seasonal differences of the sugar content of the Lemna, thus also dramatically increasing the methionine content by the addition of betaine contained in the sugar beet molasses

These 2 advantages are very important in sustainable feedstock production for Ethanol and Organic protein meal.

The sustainable Organic protein production process described herein can also support the standardization of Lemna Protein concentrate, produced from the solids that are centrifuged out at step 105, as a feedstock. Standardization is very important to a new feed product to build trust in this upcoming self-sustainable industry.

The total process is a system, without the recycled process water at step 106 there is no current affordable nitrogen source to grow duckweed organically. Currently organic duckweed produced in an industrial process does not exist and to the inventor's knowledge has never been considered a possibility. All current duckweed growing systems known to the inventor are only for sewage treatment. Duckweed growth and sometimes doubling of its weight every 24 hours is well documented in Louisiana where the first of such systems described herein is intended to be built.

This Invention can only be done as a total process, simply growing duckweed in a container using an organic fertilizer source is not within the scope of this invention. Duckweed protein content is related to the nitrogen and mineral content of the water it is grown in. This invention (including the recycling at step 106 of organic process water produced at step 105) will serve as a basis to establish the minimum capital requirements for the process to be economic and successfully producing an organic lemna yeast protein concentrate for the organic feed industry.

To the inventor's knowledge, currently no Organic Lemna Yeast product exist and that there is currently no other economically viable way to furnish the required nitrogen source for the production of Organic Lemna Yeast Protein Concentrate other than the recycling of process water from a yeast, bacteria as detailed above, or other Single Cell Protein production system.

The process described herein can give Organic feed consumers the option to build a system to produce 100% of their daily organic protein needs. This process can be 100% self sufficient by growing 100% of the needed duckweed on site. The only outside input being Organic enzymes and water treatment chemicals.

1. (canceled)

2. A method for producing protein feedstock and ethanol, the method comprising:
grinding lemna collected from growing ponds;
adding enzymes to the ground lemna and cooking to convert starch in the ground lemna to sugar;
fermenting the cooked lemna to produce ethanol from the converted sugar;
from the fermented lemna, stripping the ethanol via distillation and thereafter separating remaining solids from yeast water via centrifuge;
producing a protein feedstock from the solids;
recycling the yeast water to the growing ponds to grow a next batch of lemna.

3. The method according to claim 2, wherein the grinding, adding, fermenting, stripping, separating and producing are repeated after the yeast water is recycled to the growing ponds.

4. The method according to claim 2, wherein the enzymes comprise alpha amylase and glucoamylase.

5. The method according to claim 4, further comprising adding a betaine source to the ground and/or cooked lemna, prior to the fermenting.

6. The method according to claim 5, wherein the betaine source comprises sugar beet molasses.

7. The method according to claim 6, wherein the betaine source consists of sugar beet molasses.

8. Lemna protein feedstock produced from a second batch of lemna harvested from growing ponds into which nitrogen rich thin stillage is recycled after being separated from solids that result from processing a first batch of lemna harvested from the growing ponds.

9. The lemna protein feedstock of claim 8, wherein the lemna protein feedstock is organic.

10. The lemna protein feedstock of claim 8. wherein the processing of the first batch of lemna comprises:
grinding the first batch of lemna harvested from the growing ponds;
adding enzymes to the ground first batch of lemna and cooking to convert starch in the ground first batch of lemna to sugar;
fermenting the cooked first batch of lemna to produce ethanol from the converted sugar;
from the fermented first batch of lemna, stripping the ethanol via distillation and thereafter separating remaining solids from yeast water via centrifuge, where the yeast water is the thin stillage.

11. The lemna protein feedstock of claim 10, wherein the enzymes comprise alpha amylase and glucoamylase.

12. The lemna protein feedstock of claim 10, wherein the processing of the first batch of lemna further comprises adding a betaine source to the ground and/or cooked first batch of lemna, prior to the fermenting.

13. The lemna protein feedstock of claim 12, wherein the betaine source comprises sugar beet molasses.

14. The lemna protein feedstock of claim 13, wherein the betaine source consists of sugar beet molasses.

15. Lemna protein meal produced by an industrial process.

16. Organic lemna protein meal according to claim 15.

17. Organic lemna protein meal according to claim 15, wherein the industrial process comprises fermenting lemna collected from growing ponds.
